(19) United States
(12) Patent Application Publication
(10) Pub. No.: US 2009/0043586 A1
(43) Pub. Date: Feb. 12, 2009

(54) Detecting a Physiological State Based on Speech

(76) Inventor: Joel MacAuslan, Nashua, NH (US)

Correspondence Address: ROBERT PLOTKIN, PC, 45 BUTTERNUT CIRCLE, CONCORD, MA, 01742-1937, US

(21) Appl. No.: 11/835,990

(22) Filed: Aug. 8, 2007

(51) Int. Cl. G10L 11/00

(52) U.S. Cl. 704/270; 704/E19.001

(57) ABSTRACT

A computer-implemented method identifies a spoken audio signal representing speech of a person and estimates a physiological state of the person based on the spoken audio signal. For example, the method may identify articulatory patterns (such as landmarks) in the speech and estimate the person's physiological state based on those articulatory patterns. The method may estimate, for example, the amount of time the person has been without sleep. The method may produce the physiological state estimate without performing speech recognition on the spoken audio signal. The method may produce the physiological state estimate in real-time.

### STATEMENT AS TO FEDERALLY SPONSORED RESEARCH

This invention was made with Government support under a US Air Force SBIR Phase I grant, grant number F33615-02-M-6057; and NIH STTI Phase I and II grants, grant number R42-HD34686. The Government may have certain rights in the invention.

### BACKGROUND

At least 40 million Americans have chronic sleep problems, and an additional 20 million experience occasional sleeping problems (NIH News, Apr. 21, 2005). Sleep deprivation is a serious health issue for several reasons. First, sleep deprivation affects performance, with loss of alertness or drowsiness associated with higher rates of highway accidents, medical errors, and forgetfulness (Peters et al., 1999.) Second, chronic sleep problems, such as obstructive sleep apnea, are associated with obesity, headaches, anxiety, and depression and cardiovascular problems (http://www.nhlbi.nih.gov/new/press/apr11-00.htm). Sleep deprivation is a common concomitant of many occupations, and a special problem for shift workers. The need for more research on behavioral concomitants of sleep deprivation and associated performance degradation has been underlined in policy documents by the NIH National Center on Sleep Disorders Research, and the NHLBI strategic plan.

Sleep deprivation and sleep disorders are implicated in the disease processes of widely different disorders-neurodegenerative disorders such as Parkinson's, pain disorders such as fibromyalgia, metabolic disorders and obesity, psychiatric disorders, and endocrine disorders, among others. Sleep disruption in hospital environments can also disrupt patient response to pharmacological, physical, and behavior therapy. Logically, methods for measuring sleep deprivation are a critical tool for advancing the research agenda in each of these fields. Other interested government agencies, such as the Department of Defense (DOD) and the National Transportation Safety Board (NTSB) have advertised similar needs (DOD Human Factors Engineering “Hot Topics” at http://hfetag.dtic.mil, NTSB “Ten Most Wanted” transportation safety improvements listed on http://www.ntsb.gov).

The speech articulation of people who have not slept for 24 hours or more is typically understandable and maintains the global characteristics of the speaker's voice and diction. Perhaps because of this fact, few studies in the field of sleep research have considered the possibility that sleep deprivation changes speech articulation. When their attention is drawn to the issue, however, listeners do appear to have some intuitive ability to categorize fresh (FSH) vs. sleep-deprived (SD) speech. For example, in an interview study focused on subjects' personal experiences during sleep loss of 24 hours, Morris et al. (1960:252) noted that they heard “alterations in rhythm, tone and clarity of subjects' speech,” but made no attempt to quantify these observations. Harrison & Horne (1997) asked naive listeners whether sleep-deprived subjects reading a short story aloud (a) used intonation less appropriately and (b) sounded more “fatigued” than their rested selves and found that subjects performed at a level significantly greater than chance.

Morris et al.'s use of the music terms “rhythm” and “tone” make it difficult to interpret their exact meaning for the speech they heard; clearly “rhythm” refers to global speech timing, but in everyday use these words may describe pause timing or speech rate. “Tone” may describe some aspect of pitch, e.g., the contour of pitch change over the course of a sentence (also called intonation), or use of a different pitch range. Harrison & Horne's use of the word “intonation” is likewise unclear. It may refer to pitch contour, speech timing, speech rate, changes in loudness, or pitch range. Presumably, Morris et al. (1960) used the word “clarity” to mean articulatory clarity but the phrase may mean vocal quality. Thus, we can conclude that the listeners in these studies registered some quality in what they heard that indicated sleep deprivation or fatigue, but we do not know exactly what. Neither team or researchers measured speech articulation or intelligibility directly, but it would seem from their report that the speech articulation of their subjects under sleep deprivation remained intelligible and characteristic.

### SUMMARY

A computer-implemented method identifies a spoken audio signal representing speech of a person and estimates a physiological state of the person based on the spoken audio signal. For example, the method may identify articulatory patterns (such as landmarks) in the speech and estimate the person's physiological state based on those articulatory patterns. The method may estimate, for example, the amount of time the person has been without sleep. The method may produce the physiological state estimate without performing speech recognition on the spoken audio signal. The method may produce the physiological state estimate in real-time.

For example, one embodiment of the present invention is directed to a computer-implemented method comprising: (A) identifying a spoken audio signal representing conversational speech of a person; and (B) identifying an estimate of an amount of time the person has been without sleep based on the spoken audio signal.

Another embodiment of the present invention is directed to a computer-implemented method comprising: (A) identifying a spoken audio signal representing speech of a person; (B) identifying articulatory patterns of the speech; and (C) identifying an estimate of an amount of time the person has been without sleep based on the articulatory patterns.

Other features and advantages of various aspects and embodiments of the present invention will become apparent from the following description and from the claims.

### BRIEF DESCRIPTION OF THE DRAWINGS

FIG. 1 is a dataflow diagram of a system for detecting a physiological state of a person based on an audio signal representing speech of the person; and

FIG. 2A is a flowchart of a method performed by the system of FIG. 1 according to one embodiment of the present invention.

### DETAILED DESCRIPTION

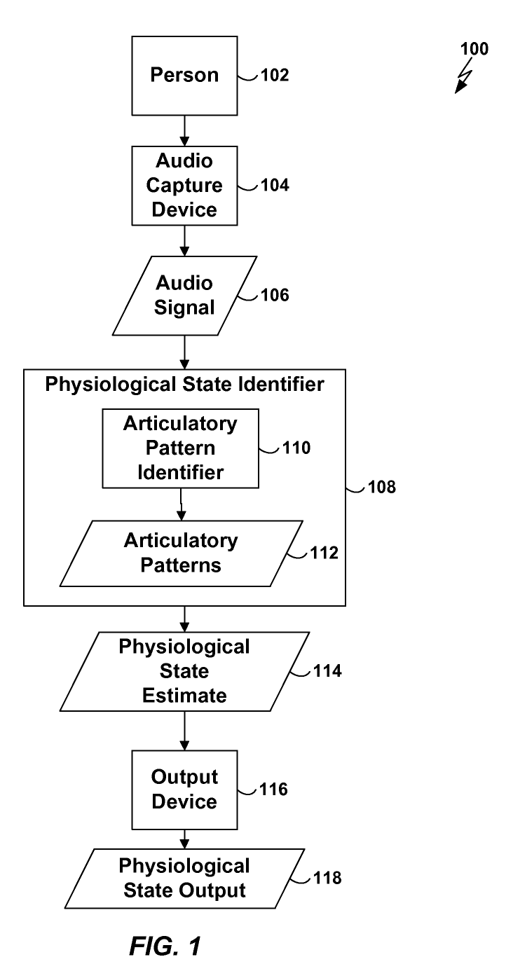

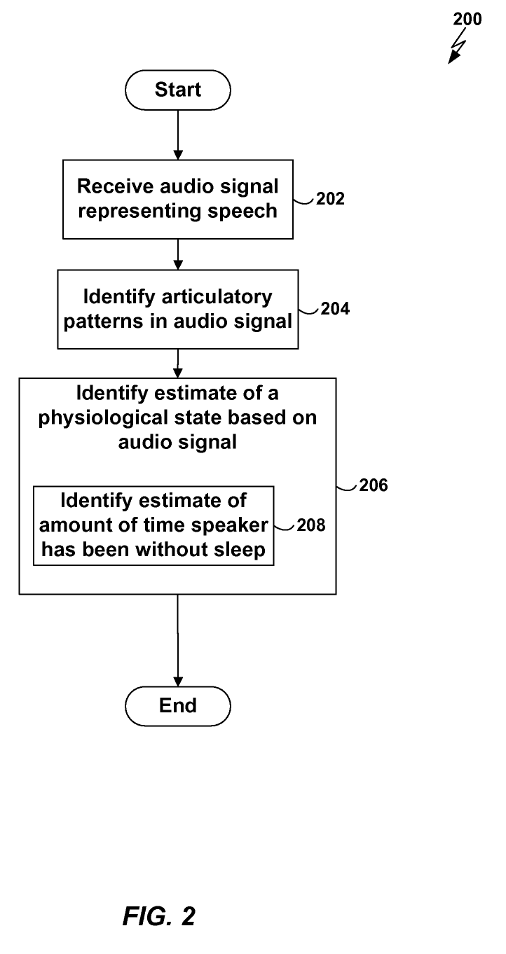

Referring to FIG. 1, a dataflow diagram is shown of a system 100 for detecting a physiological state of a person 102 based on an audio signal 106 representing utterances of the person 102, according to one embodiment of the present invention. Referring to FIG. 2A, a flowchart is shown of a method 200 performed by the system 100 of FIG. 1 according to one embodiment of the present invention.

The system 100 includes an audio capture device 104, which captures sounds emitted by the person 102, and which outputs an audio signal 106 representing the captured sounds. The audio capture device 104 may, for example, include a microphone. The audio capture device 104 may include an audio recording component, such as a digital audio recorder or a tape recorder for making a tangible record of the captured sounds.

The sounds captured by the audio capture device 104 may or may not include speech. For example, the audio capture device 104 may be installed in the cab of a truck, in which case the audio capture device 104 may capture any sounds emitted by the truck driver, such as those produced by humming, whistling, sneezing, or other non-speech acts. In such an application, the audio capture device 104 may also capture speech of the person 102, such as words spoken by the person 102 to a passenger in the cab or over a separate CB radio. The audio signal 106 may, therefore, represent speech, non-speech sounds, or any combination thereof.

The system 100 also includes a physiological state identifier 108, which receives the audio signal 106 (FIG. 2, step 202) and identifies an estimate 114 of a physiological state of the speaker 102 based on the audio signal 106 (step 206). The physiological state identifier 108 may identify the estimate 114 in any of a variety of ways. For example, the physiological state identifier 108 may include an articulatory pattern identifier 110 which identifies articulatory patterns 112 in the speech represented by the audio signal 106 (step 204). The physiological state identifier 108 may then identify the estimate of the physiological state of the speaker based on the articulatory patterns 112.

“Landmarks” are examples of articulatory patterns that may be identified in the speech represented by the audio signal 106. Landmark analysis is a method of marking points in an acoustic signal that correspond to phonetically and/or articulatorily important events. For example, one type of landmark is associated with abrupt constriction of the vocal tract for obstruent consonants; e.g., closure and release for stop consonants such as /p/, /t/ and /k/, or sudden onset of aperiodic noise for fricatives such as /s/ or /f/. One type of landmark is linked to laryngeal activity and can be used to identify points in the signal where the vocal folds are vibrating in a periodic fashion. Other landmarks identify intervals of sonorancy; i.e., intervals when the vocal tract is relatively unconstricted, as in /r/, /l/ or /w/.

In general, landmark processing begins by analyzing the audio signal 106 into several broad frequency bands. First, an energy waveform is constructed in each of the bands. Then the rate of rise (or fall) of the energy is computed, and peaks in the rate are detected. These peaks therefore represent times of abrupt spectral change in the bands. In addition, a periodicity detection algorithm may provide information regarding laryngeal vibration. This is referred to variously in literature as vocal fold vibration, glottal vibration, phonation, or voicing.

The next processing stage after detection of abrupt changes is to group them into landmarks. Large, abrupt energy increases or decreases that occur simultaneously across several of the bands are first noted, and then interpreted with respect to the timing of the voicing band. When too few bands show large, simultaneous changes in energy, the processor does not register a landmark. When all bands show large, simultaneous energy increases immediately before the onset of voicing, the processor identifies a +b (burst) landmark. When all bands show large, simultaneous energy increases during ongoing voicing, the processor identifies a +s (syllabic) landmark. Particular types of consonants in the signal can be identified as particular sets of simultaneous peaks in several bands. This is the way landmark analysis is used in speech recognition applications.

Because it detects only changes in the acoustic signal, the Landmark system makes no overt reference to particular sound sequences, words, or sentences. For example, the words “aah,” “bah,” “bat,” and “batch” would have the same representation in landmark clusters as the words “ooh,” “go,” “grit,” and “that's,” respectively. Note that syllables of the same duration may have different numbers of landmarks.

The output of the initial landmark processing is a table indicating the number of times a particular syllabic cluster type occurred in the speech sample. The landmark processing system may also categorize the number of utterances, e.g., into groups of syllable clusters separated by approximately 350 ms of silence.

The physiological state identifier 108 may identify any of a variety of physiological states. For example, the physiological state identifier 108 may identify an estimate of the amount of time the speaker 102 has been without sleep (step 208). As yet another example, the physiological state identifier 108 may identify an estimate of whether the person 102 is in a fatigued state.

Although the physiological state identifier 108 may identify features (such as articulatory patterns 112) of speech represented by the audio signal 106, the physiological state identifier 108 need not perform speech recognition on the audio signal 106. Rather, the physiological state identifier 108 may, for example, identify the articulatory patterns 112 represented by the audio signal 106 without performing speech recognition on the audio signal 106. The physiological state identifier 108 may produce the physiological state estimate 114 based on the articulatory patterns 112, rather than on text or other data of the kind typically produced by an automatic speech recognizer.

The audio signal 106 that is provided to the physiological state identifier 108 may be a “live” or pre-recorded audio signal. For example, the audio capture device 104 may include a microphone and provide the audio signal 106 to the physiological state identifier 108 as the speaker 102 is speaking, i.e., in real-time. The physiological state identifier 108 may, in turn, identify the physiological state estimate 114 as the audio signal 106 is received by the physiological state identifier 108, i.e., in real-time. As a result, the physiological state identifier 108 may produce the physiological state estimate 116 in real-time with respect to the speech of the speaker 102.

For example, the physiological state identifier 108 may begin to receive the audio signal 106 and begin to identify the physiological state estimate 114 at the same or substantially the same time as the physiological state identifier 108 begins to receive the audio signal 106. The physiological state identifier 108 may, for example, continue to receive the audio signal 106 and produce the physiological state estimate 114 after processing up to about one minute of speech in the audio signal 106. If the physiological state identifier 108 is processing the audio signal 106 in real time, then the physiological state identifier 108 may, for example, produce the physiological state estimate 114 within about one minute of beginning to identify the estimate of the physiological state.

Alternatively, for example, the audio signal 106 may be a recorded audio signal. For example, the audio capture device 104 may include a digital audio recorder. The audio capture device 104 may record sounds emitted by the person 102 and create a recording of those sounds on a tangible medium, such as a digital electronic memory. As some later time, the audio capture device 104 may provide the recording to the physiological state identifier 108 in the form of the audio signal 106. Note that in these and other embodiments of the present invention, the audio signal 106 may be stored and/or transmitted in any format.

As a result, the physiological state identifier 108 may identify the physiological state estimate 114 based on a recorded audio signal. Note further that there is not a bright line distinguishing “live” from “recorded” audio signals. For example, the audio capture device 104 may buffer a portion (e.g., 10 seconds) of the sounds captured from the speaker 102 and thereby introduce a delay into the audio signal 106 that is provided to the physiological state identifier 108. In such a case, the audio signal 106 would be “recorded” in the sense that each segment of the audio signal 106 is recorded and stored for a short period of time before being provided to the physiological state identifier 108, but would be “live” in the sense that portions of the audio signal 106 are provided to the physiological state identifier 108 while subsequent portions of the audio 106 are being captured and stored for transmission by the audio capture device 104. Embodiments of the present invention may be applied to audio signals that are “recorded” or “live” in any combination.

Furthermore, even if the sounds emitted by the speaker 102 are fully recorded before being played back to the physiological state identifier 108 in the form of the audio signal 106, the physiological state identifier 108 may still produce the physiological state estimate 114 in real-time in relation to the playback of the recorded audio signal 106.

Embodiments of the present invention have a variety of uses. In general, lack of sleep, and the health problems that are caused by lack of sleep, are significant problems for public health. One key component of effective research on sleep health is the ability to objectively track and measure degradation in performance due to sleep deprivation. At present, available tools such as self-report, behavioral testing, and laboratory testing are either subjective, time-consuming, or invasive. More convenient measures have been sought for some time.

Embodiments of the present invention address this problem by providing techniques for assessing sleep deprivation in a way that is non-invasive, objective, automatic, and operates in real-time. Additionally, embodiments of the present invention may be used specifically to identify and quantify sleep deprivation. Embodiments of the present invention, therefore, may be of practical use in many ways to reduce the impact of sleep deprivation on health care and public safety. For instance, the ability to track sleep deficit and associated performance may be helpful for physicians whose training requires long hours, or public safety personnel in crisis mode, as just two examples.

Various embodiments of the present invention provide these benefits by analyzing patterns of speech articulation. Researchers interested in sleep deprivation have not historically considered speech as either an index of impairment, or a window into neurological mechanisms of performance. This may be because the way people articulate speech when sleep-deprived is not degraded in ways that the average listener tends to notice. However, sleep deprivation has been shown to impact a number of neurological functions that interact with speech. Some other types of stress (such as workload stress and environmental stress) have been shown to affect patterns of speech. Thus, it is reasonable to expect that sleep deprivation may affect speech articulation in reliably identifiable ways.

We have used conventional measures such as average voice pitch plus a more novel technique known as Landmark Feature Detection to compare recorded speech data from subjects in a “fresh” (FSH) condition, and in a “sleep-deprived” (SD) condition 48 hours later. One advantage of the Landmark approach is that it is both summative and combinatorial, that is, it simultaneously processes patterns in many simple measures of speech production such as average voice pitch, syllable duration and breathiness. Combinations of measures are more likely to be specific to a particular state (such as sleep deprivation) than single measures. For instance, even if average voice pitch changes under sleep deprivation, it cannot be specific, because voice pitch varies with emotional state and sentence choice.

We have found that subtle articulatory patterns automatically extractable from the acoustic spectrum can differentiate the speech articulation of rested individuals from that of sleep-deprived individuals. In particular, our results demonstrate that certain articulatory patterns are more prevalent in FSH speech, while other articulatory patterns are more prevalent in SD speech. Further, (1) FSH and SD speech patterns were significantly different for each subject (p<0.002), and (2) there was minimal overlap of speech pattern distributions between conditions for each subject. These results support the conclusion that speech articulation is measurably different under sleep deprivation in reliably identifiable ways.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The audio signal 106 may represent any kind of speech. For example, the audio signal 106 may represent conversational speech or recited speech (sometimes referred to as “read speech”). In general, the term “conversational speech” refers non-rehearsed, free speech, such as speech that is part of a dialogue, without hyperarticulation or the intentional insertion of pauses. In general, the term “recited speech” refers to speech in which pauses are intentionally inserted or which is otherwise spoken in a style intended to make it easier for a hearing-impaired listener or an automatic speech recognizer or other computer-implemented system to process.

Speech researchers distinguish been “speech production,” meaning the movement or oral articulators (e.g., the lips, tongue, jaw, and velum), vs. “voice production,” meaning the vibration of the laryngeal vocal folds to produce a periodic source signal for both speech and singing. However, the production of speech requires close coordination between laryngeal and oral articulators. As used herein, the terms “speech articulation” and “speech production” refer to the complex coordinative effort of oral plus laryngeal articulators whose output is speech.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, such as personal digital assistants (PDAs) and cellular telephones, which may be used in conjunction with any digital print engine or marking engine, display monitor, or other raster output device capable of producing color or gray scale pixels on paper, film, display screen, or other output medium.

What is claimed is:

1. A computer-implemented method comprising:
(A) identifying a spoken audio signal representing conversational speech of a person; and
(B) identifying an estimate of an amount of time the person has been without sleep based on the spoken audio signal.

2. The method of claim 1, wherein (B) comprises determining whether the person is an a fatigued physiological state based on the spoken audio signal.

3. The method of claim 1, wherein (B) comprises:
(B)(1) identifying articulatory patterns of the conversational speech based on the spoken audio signal; and
(B)(2) identifying the estimate of the amount of time the person has been without sleep based on the articulatory patterns.

4. The method of claim 4, wherein the articulatory patterns comprise landmarks.

5. The method of claim 1, wherein (B) comprises identifying the estimate of the amount of time the person has been without sleep without performing speech recognition on the spoken audio signal.

6. The method of claim 5, wherein (B) comprises identifying the estimate of the amount of time the person has been without sleep without recognizing phonemes, syllables, or words in the spoken audio signal.

7. The method of claim 1, wherein (A) comprises identifying a live spoken audio signal being spoken by the person, and wherein (B) comprises identifying the estimate of the amount of time the person has been without sleep as the live spoken audio signal is being spoken.

8. The method of claim 7, wherein (B) comprises:
(B)(1) beginning to identify the estimate of the amount of time the person has been without sleep; and
(B)(2) identifying the estimate of the amount of time the person has been without sleep within about one minute of beginning to identify the estimate of the amount of time the person has been without sleep.

9. The method of claim 1, wherein (A) comprises identifying a recorded spoken audio signal representing conversational speech of the person being played back by a player, and wherein (B) comprises identifying the estimate of the amount of time the person has been without sleep based on the recorded spoken audio signal.

10. The method of claim 9, wherein (B) comprises identifying the estimate of the amount of time the person has been without sleep in real-time in relation to the playback of the recorded spoken audio signal.

11. An apparatus comprising:
audio signal identification means for identifying a spoken audio signal representing conversational speech of a person; and
sleep deprivation estimation means for identifying an estimate of an amount of time the person has been without sleep based on the spoken audio signal.

12. The apparatus of claim 11, wherein the sleep deprivation estimation means comprises means for determining whether the person is an a fatigued physiological state based on the spoken audio signal.

13. The apparatus of claim 11, wherein the sleep deprivation estimation means comprises:
means for identifying articulatory patterns of the conversational speech based on the spoken audio signal; and
means for identifying the estimate of the amount of time the person has been without sleep based on the articulatory patterns.

14. The apparatus of claim 13, wherein the articulatory patterns comprise landmarks.

15. A computer-implemented method comprising:
(A) identifying a spoken audio signal representing speech of a person;
(B) identifying articulatory patterns of the speech; and
(C) identifying an estimate of an amount of time the person has been without sleep based on the articulatory patterns.

16. The method of claim 15, wherein (C) comprises determining whether the person is in a fatigued physiological state.

17. The method of claim 15, wherein the articulatory patterns comprise landmarks.

18. The method of claim 15, wherein (C) comprises identifying the estimate of the amount of time the person has been without sleep without performing speech recognition on the spoken audio signal.

19. The method of claim 18, wherein (C) comprises identifying the estimate of the amount of time the person has been without sleep without performing speech recognition on the spoken audio signal.

20. The method of claim 19, wherein (C) comprises identifying the estimate of the amount of time the person has been without sleep without recognizing phonemes, syllables, or words in the spoken audio signal.

21. The method of claim 15, wherein (A) comprises identifying a live spoken audio signal being spoken by the person, and wherein (C) comprises identifying the estimate of the amount of time the person has been without sleep as the live spoken audio signal is being spoken.

22. The method of claim 15, wherein (A) comprises identifying a recorded spoken audio signal representing speech of the person being played back by a player, and wherein (C) comprises identifying the estimate of the amount of time the person has been without sleep based on the recorded spoken audio signal.

23. The method of claim 15, wherein (C) comprises identifying the estimate of the amount of time the person has been without sleep in real-time in relation to the playback of the recorded spoken audio signal.

24. The method of claim 22, wherein (C) comprises:
(C)(1) beginning to identify the estimate of the amount of time the person has been without sleep; and
(C)(2) identifying the estimate of the amount of time the person has been without sleep within ten seconds of beginning to identify the estimate of the physiological state.

25. An apparatus comprising:
audio signal identification means for identifying a spoken audio signal representing speech of a person; and
articulatory pattern identification means for identifying articulatory patterns of the speech; and
sleep deprivation estimation means for identifying an estimate of an amount of time the person has been without sleep based on the articulatory patterns.

26. The apparatus of claim 24, wherein the sleep deprivation estimation means comprises means for determining whether the person is in a fatigued physiological state.

27. The apparatus of claim 24, wherein the articulatory patterns comprise landmarks.
